(19) United States
(12) Patent Application Publication
(10) Pub. No.: US 2011/0210219 A1
(43) Pub. Date: Sep. 1, 2011

(54) Poster Hanging Bar

(75) Inventor: Tomas Pedersen, Stovring (DK)

(73) Assignee: TP HOLDING HADSUND APS, Hadsund (DK)

(21) Appl. No.: 13/061,858

(22) PCT Filed: Aug. 24, 2009
(86) PCT No.: PCT/DK2009/000186

§ 371 Date: May 18, 2011

(30) Foreign Application Priority Data
Sep. 11, 2008 (DK) PA 2008 01277

(51) Int. Cl. F16M 13/02

(52) U.S. Cl. 248/231.91

(57) ABSTRACT

The invention relates to a poster hanging bar for reinforcement of the edge of items such as posters, which are to be suspended on a wall or from a ceiling. A bar is used, which can be made of a metallic material, for the edge reinforcement and the bar is pressed around the edge of the poster. The bar is fastened to the poster either by clamping of end points, which are situated after angular shapes on the bar, or by the bar being exposed to point by point deformations and an angular shape, which gives the edge reinforcement bar a distinctive mechanical strength. The edge reinforcement process can be automated, whereby the demands for manual labor are minimized. The components are inexpensive, readily available and the finished edge reinforcement is highly robust and durable.

### TECHNICAL FIELD

The invention relates to a poster hanging bar for edge reinforcement and hanging of items such as posters, pictures and placards including images depicted e.g. by print on materials such as paper, fabric or plastic.

### BACKGROUND

It is known to reinforce the edge of items such as posters, pictures and placards in connection with the hanging of these items.

The edge, which is to be reinforced, will typically be the upper edge, which is used for fastening the item for hanging.

The hitherto most used technique for edge reinforcement, which is e.g. typically used for large posters, is that the upper part of the poster is folded around a rod and is sewn together around the rod.

The upper edge of the poster is thereby reinforced by the sewn in rod.

It has been found, however, that there are some drawbacks to the known technique, including that it is time-consuming and expensive to sew rods in as edge reinforcement.

The sewing will typically also demand use of manual labour consisting of trained sewing machinists, which makes the process vulnerable to e.g. the availability of workers.

### SUMMARY OF THE INVENTION

It is therefore an object of the invention to improve the known poster hanging bar.

The object of the invention is achieved by a poster hanging bar which is characterized in that the poster hanging bar is folded, preferably symmetrically, around the edge of the item at an angle, which is preferably 180 degrees, and that the poster hanging bar is pressed together around the item preferably by clamping of the poster hanging bar at the end points, which follow at least one angle, which is preferably between 140 and 170 degrees and more preferably between 150 and 160 degrees.

In this way it thus becomes possible to edge reinforce e.g. posters without any kind of sewing, by simple clamping of the poster hanging bar around the poster according to a method, which is easily automated.

### BRIEF DESCRIPTION OF THE DRAWINGS

The invention will now be explained more fully with reference to the drawings, in which:

FIG. 1 shows, seen from the side, a simplified diagram of an edge, which is to be edge reinforced by a bar, where the edge is guided and put into the open bar.

FIG. 2 shows, seen from the side, the same configuration as in FIG. 1, but where the bar is now pressed around the edge, which is to be reinforced.

FIG. 3 shows, seen from the side, the same configuration as in FIG. 2, but where the bar is now pressed around a point.

FIG. 4 shows, seen from the side, the same configuration as in FIG. 3, but where the bar is now also bent at an angle.

FIG. 5 shows a simplified diagram of a step in an edge reinforcement process, similar to the one shown in FIG. 3, but depicted in another projection.

FIG. 6 shows, in a cross section, a simplified diagram of a bar holder.

FIG. 7 shows, in a cross section, a simplified diagram of a bar holder as in FIG. 6, with an edge reinforced poster top inserted therein.

FIG. 8 shows a photo of a segment of an edge reinforced poster partially mounted in a bar holder.

FIG. 9 shows an open poster hanging bar similar to the poster hanging bar shown in FIG. 1.

FIG. 10 shows how angles are added to the poster hanging bar in the direction facing the end points.

FIG. 11 shows the poster hanging bar with angles facing towards the end points with an item, which is to be edge reinforced, inserted therein.

FIG. 12 shows how the poster hanging bar with angles at the end points secures the item, which is edge reinforced by clamping of the end points.

### DETAILED DESCRIPTION OF THE INVENTION

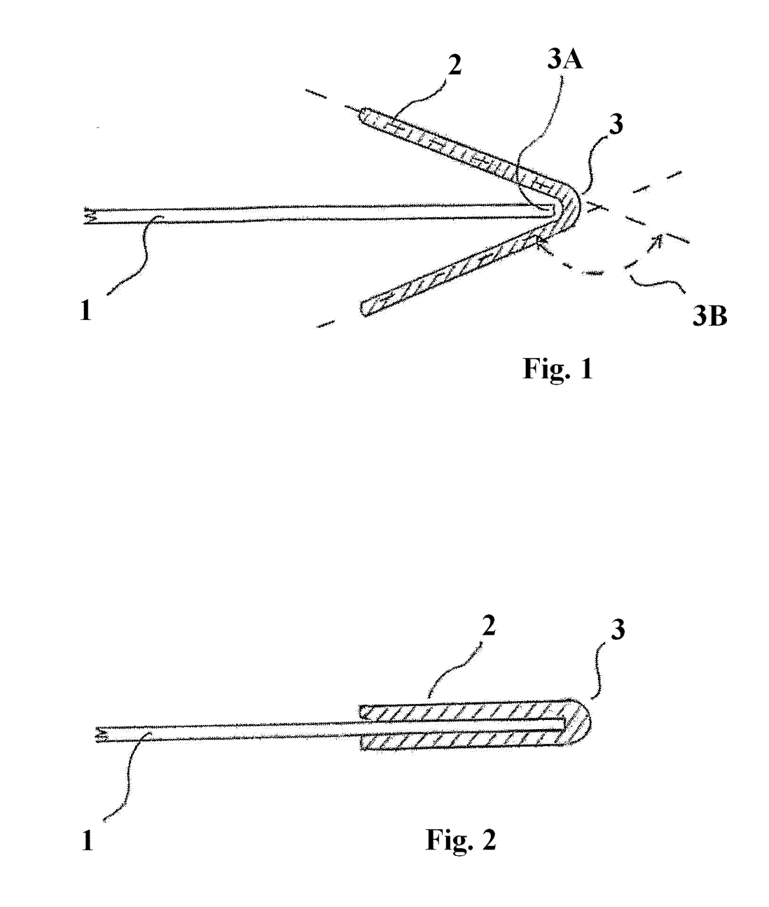

Referring to FIG. 1, an upper part of an item 1 such as a poster, is seen from the side, the item to be suspended from an edge 3A, with the edge 3A after suspension being at the top.

The poster 1 is placed in the bottom of a partially open bar 2, which is preferably symmetrical around a bend 3.

The bar 2 is folded at an angle 3B.

FIG. 1 thus principally depicts the first step of the edge reinforcement process.

In FIG. 2, the second step in the edge reinforcement process is shown, which is characterized in that the bar 2 is now folded, pressed, clamped and/or glued around the edge 3A of the poster 1, with the angle 3B now preferably at 180 degrees.

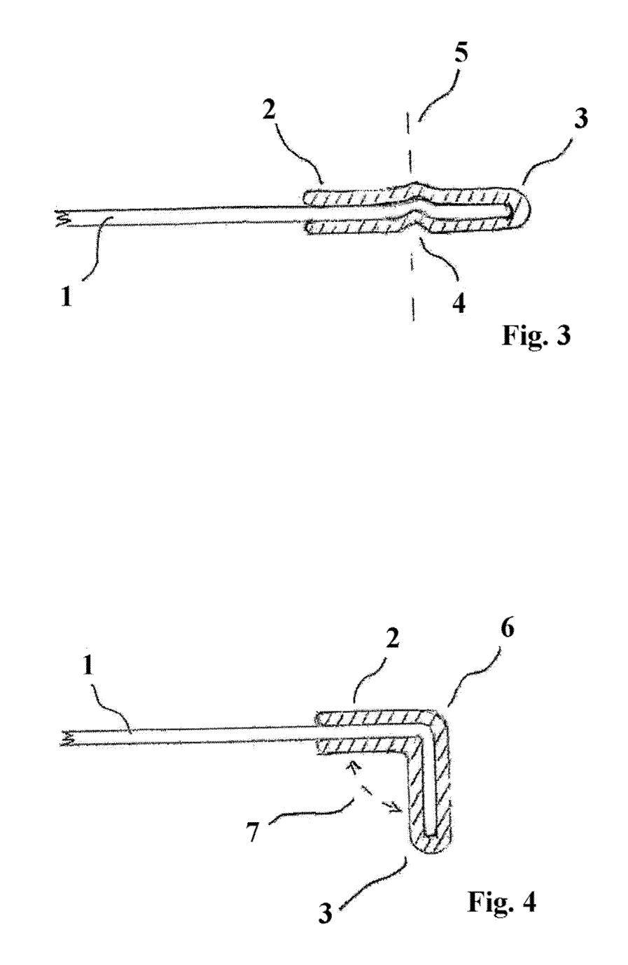

The third step in the edge reinforcement process is shown in FIG. 3, where the bar 2 has been subjected to point by point or area limited deformations 4, which occur in the direction of line 5 and thereby create an extra powerful fastening of the item 1 in the bar 2.

The point by point deformations 4 can be manufactured by pressing, striking or by another known deformation technique.

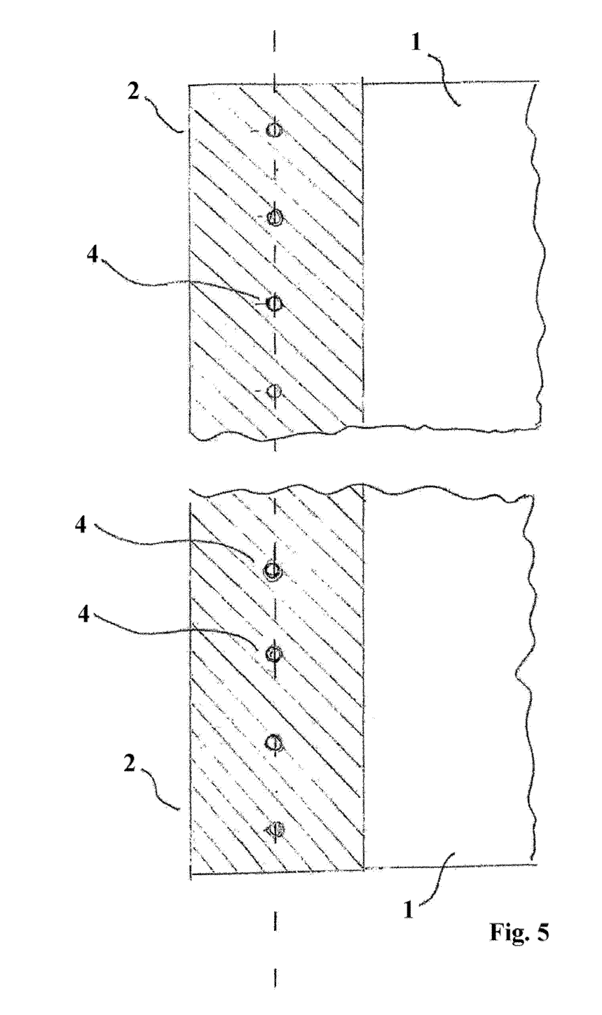

Referring to FIG. 5, the point by point deformations 4 of FIG. 3 are depicted in another projection, corresponding to the one in which the motif of the item 1 can be seen, where several preferably parallel points of deformation 4 are shown.

The fourth and last step in the edge reinforcement process is depicted in FIG. 4, where the bar now is bent at an angle 7, which is preferably 90 degrees or less.

The angle 7 is preferably located symmetrically on the bar 2, corresponding to the axis 5 from FIG. 3, around which the point by point deformations 4 were created.

The shown angle 7 provides a significant increase in strength of the whole edge reinforcement.

The edge reinforcement of the item 1 shown in FIG. 4, which can typically be a poster, is characterized in being highly robust, especially if a metal is chosen as the bar material.

It is also simple and inexpensive to automate the shown process, such that the edge reinforcement can be carried out without application of manual labor, or alternatively solely by application or use of workers who are in principle unskilled.

A poster 1, which is edge reinforced as shown in FIG. 4, can be suspended directly in the edge reinforcing bar 2.

This can be done e.g. by making the bar 2 a little wider than the poster 1, whereby the parts of the bar, which jut out, can be used for load carrying in connection with suspension on e.g. wall nails.

It is also possible to provide the poster hanging bar 2 with holes or similar features for penetration of fastening devices such as pins or screws, which can e.g. be placed into a wall where the poster 1 is to hang.

Often, it will however be a preferred solution, including for aesthetic reasons, to use a special bar holder as a transition element located between the edge reinforced poster 1 and the wall or the ceiling from which the poster 1 shall hang.

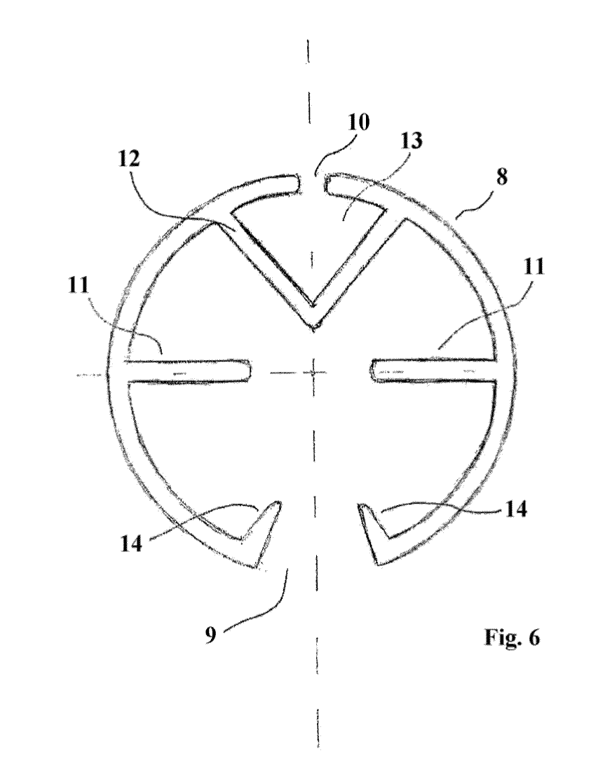

FIG. 6 shows a cross section of a preferred type of bar holder 8, which is manufactured to be suited for use with the edge reinforced poster 1 shown in FIG. 4.

The bar holder 8 is manufactured to have an opening 10 in the top and an opening 9 in the bottom and is furthermore provided with internal walls (11,12, 14), which reinforce the bar holder 8 and divide an internal cavity of the bar holder 8.

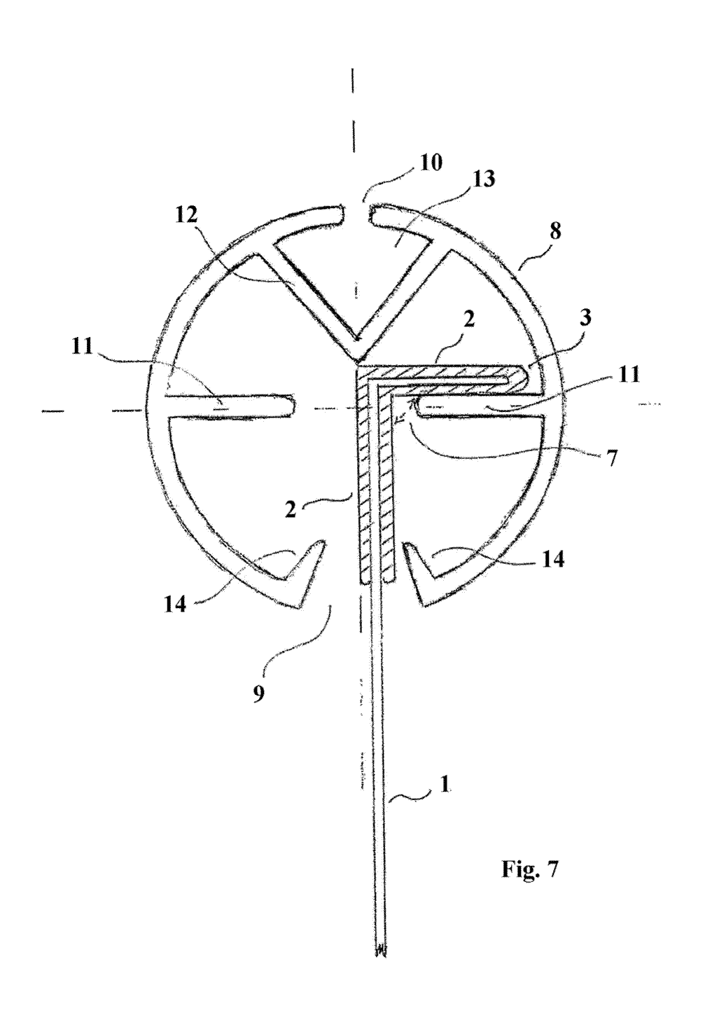

FIG. 7 shows the same bar holder 8, of FIG. 6, with an edge reinforced poster 1 placed in the bar holder 8.

As it will appear from FIG. 7, the bar holder 8 is shaped in such a way that the bar 2 exactly fits into the shown section.

The bar 2 thus rests on an internal wall 11 and also is blocked from transverse horizontal movements by the internal walls 14 and the internal wall 11, which the poster hanging bar 2 does not rest on.

At the same time, the bar 2 is blocked for movement in the vertical plane in the shown section by the walls 12, which prevent an upwards movement and the walls 11 and the walls 14 which together prevent a downward movement.

FIG. 7 illustrates that the bar 2 and thereby the edge reinforced poster 1 can be moved freely in the plane, which is perpendicular in the shown depiction.

For the same reason, this freely movable plane is used to insert the bar 2 and thereby the poster 1 in the bar holder 8.

It is a part of the invention that the ends of the bar holder 8 can be closed with appropriately shaped items such as plugs.

The suspension of both the bar holder 8 and the poster 1 can now easily be established via insertion of suspension items such as wires or cords with end knots or pins which am inserted into the cavity 13, such that the wire or the cord comes out from the bar holder 8 via the opening 10.

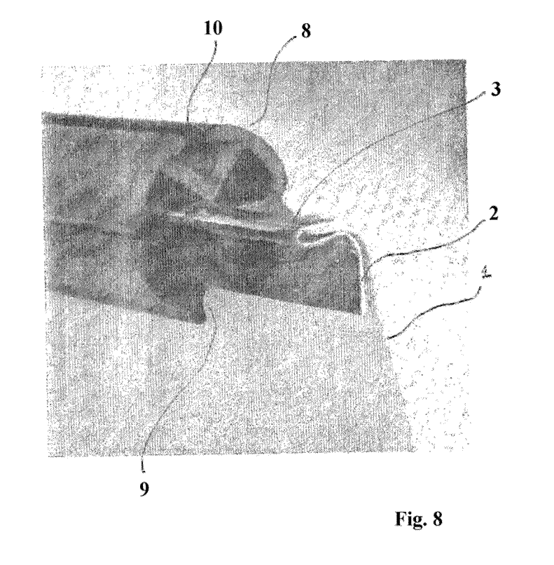

FIG. 8 is a photo of a preferred embodiment of a bar holder 8 with a partially inserted poster 1, which is reinforced with a bar 2.

The bar holder 8 can be manufactured from a metallic material including an iron-bearing magnetic material or be manufactured from a polymer such as by extrusion.

Besides the shown approximately circular outer shape, the bar holder 8 can have other outer shapes including multi angled and quadrangular.

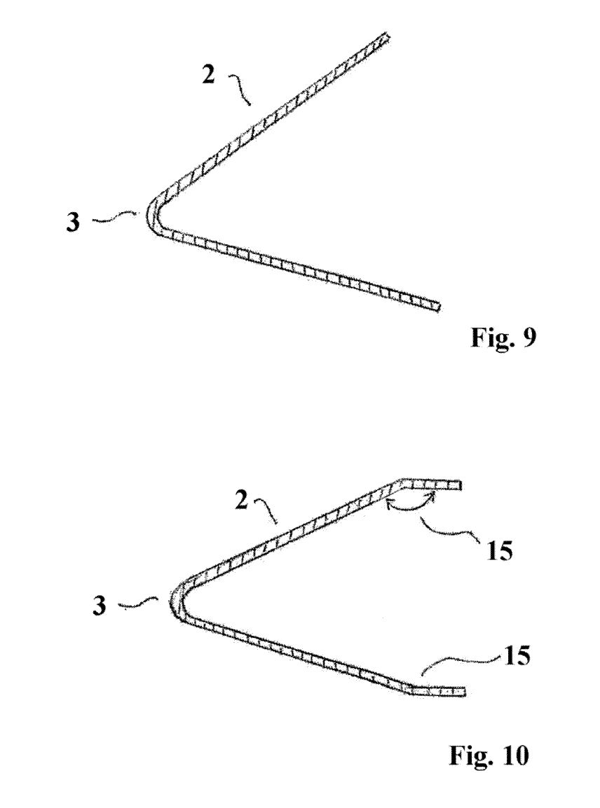

FIG. 9 shows, seen from the side, an open poster hanging bar for edge reinforcement of items such as posters, where the poster hanging bar is shaped to have a bend 3 similar to the bar from e.g. FIG. 1.

In FIG. 10 is shown how the bar 2 from FIG. 9 is processed to include angles 15, which are preferably between 140 and 170 degrees and more preferably between 150 and 160 degrees.

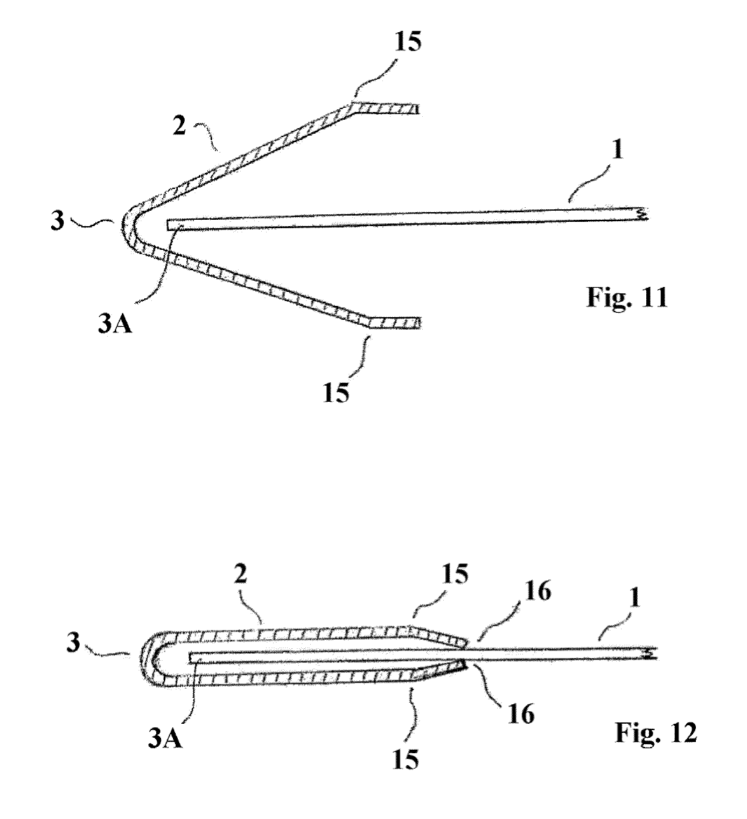

As shown in FIG. 11, an item 1 can be placed in the opening of the bar 2, which can subsequently be clamped of pressed around an item 1, as shown in FIG. 12.

From FIG. 12 it is seen that the bar 2 after clamping around the item 1 fastens the item by touching with the ends 16.

The angles 15 create bent ends 16, which face each other, which by clamping with each other around the item 1 will expose the item 1 to a slight deformation, whereby the friction between the ends 16 and the item 1 results in a strong attachment between the bar 2 and the item 1.

The angles 15 are also contributing to stabilize and strengthen the bar 2 in its longitudinal direction.

The functionality of the mounting of the poster hanging bar 2 to the item 1, as shown in FIGS. 10 to 12, can also be carried out with only one angle 15 added to an item 2. The friction between the bar 2 and the item 1 will however be largest when the bar 2 is shaped with two angles 15.

An item 1, which is edge reinforced with a poster hanging bar 2 according to the method shown in FIGS. 10 and 12 can be placed in a bar holder by insertion into such a holder when the bar holder is simply shaped according to the dimensions of the poster hanging bar.

1. (canceled)

2. A poster hanging bar (2) for reinforcing an edge (3A) of an item (1) such as a poster, a picture or a placard, and for hangably supporting the item, the poster hanging bar comprising a bar (2) having a bend (3) for receiving the edge (3A) of the item therein, the poster hanging bar being foldable about the bend (3) and over the edge (3A) of the item (1) for pressing against the edge of the item (1), clamping the item therein, the bar having at least one angle (15) incorporated therein, of between 140 and 170 degrees, for forming at least one angled end point, the angled end point engaging the item for holding the item within the poster hanging bar.

3. The poster hanging bar of claim 1 wherein the poster hanging bar is foldable around the bend (3) at an angle (3B) which is preferably 180 degrees.

4. The poster hanging bar of claim 1 wherein the at least one angle is between 150 and 160 degrees.

5. The poster hanging bar of claim 1 wherein the bar has two angles (15) for forming a pair of opposed angled end points for gripping the item therebetween.

6. The poster hanging bar of claim 1 wherein the bend (3) is symmetrically positioned.
